(19) United States
(12) Patent Application Publication
(10) Pub. No.: US 2011/0106980 A1
(43) Pub. Date: May 5, 2011

(54) SYSTEM AND METHOD FOR TESTING PERIPHERAL USB EQUIPMENT OF ELECTRONIC DEVICE

(75) Inventor: QING-HUA LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/698,970

(22) Filed: Feb. 2, 2010

(30) Foreign Application Priority Data
Oct. 30, 2009 (CN) 200910309094.X

(51) Int. Cl. G06F 13/12; G06F 11/34

(52) U.S. Cl. 710/8; 714/43; 714/E11.206

(57) ABSTRACT

A system for testing peripheral USB devices includes a test module and a plurality of USB ports equipped on an electronic device. The plurality of USB ports connects to a plurality of USB device. Each of the USB device includes a VID and a PID. The test module includes a storage module which stores a plurality of VIDs and PIDs. The test module connects to the plurality of USB ports, reads VIDs and PIDs of the plurality of USB device, and compares the VIDs and PIDs of the plurality of USB device with the VIDs and PIDs stored in the storage module.

### BACKGROUND

1. Technical Field

The present disclosure relates to systems and methods for testing peripheral equipments of an electronic device, and more particularly to a system and method for testing peripheral USB device of an electronic device.

2. Description of Related Art

USB was originally developed in 1995 to define an external expansion bus, which facilitates the connection of additional peripherals to an electronic device, such as PCs (Personal Computers).

According to USB specifications, in order for the peripheral output/input device of a PC to provide a function of plug and play, each function should be provided with Vendor Identification (VID)/Product Identifier (PID) for identification by the PC. Since VID from different manufacturers of USB products are not identical, and even the same series of products by the same manufacturer may have different PID (such as in USB keyboards, the scanning method and language may be different and lead to different PID), the VID and PID is important for the functioning of the device.

In manufacturing electronic devices, such as PCs, it is necessary to check the IDs of peripheral USB device, however, the conventional method for checking the peripheral USB device is to do it manually one by one, which is inefficient.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a system for testing peripheral USB device of an electronic device.

FIG. 2 is a block diagram of the electronic device of FIG. 1.

FIG. 3 is a flow diagram of a method for testing peripheral USB device of an electronic device.

FIG. 4 is a block diagram of the electronic device of FIG. 1 with another storage unit.

FIG. 5 is a flow diagram of another method for testing peripheral USB device of an electronic device.

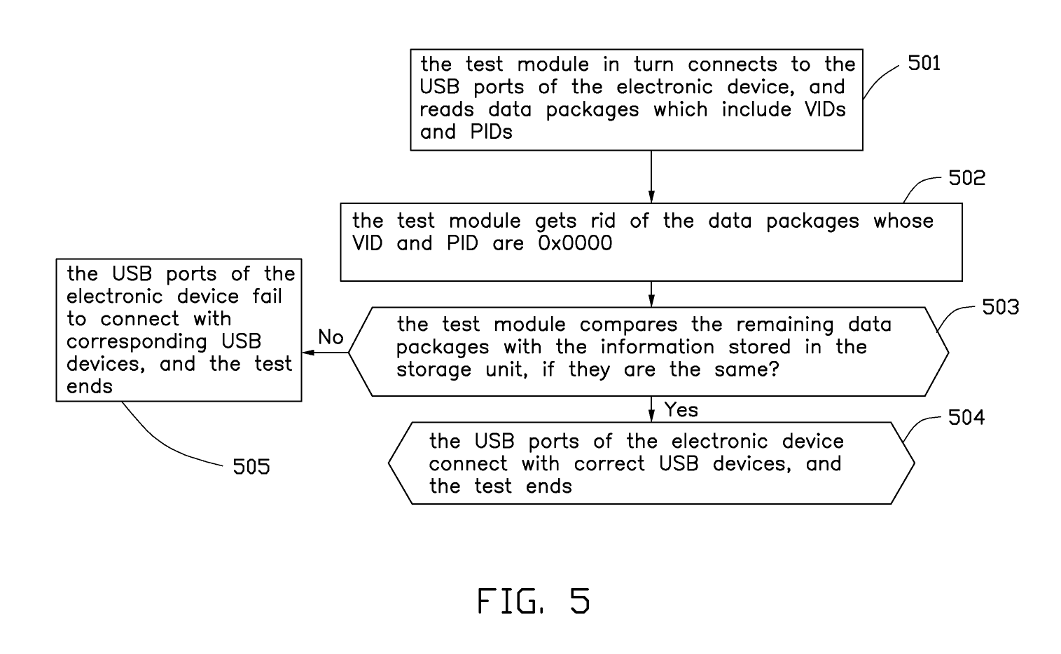

### DETAILED DESCRIPTION

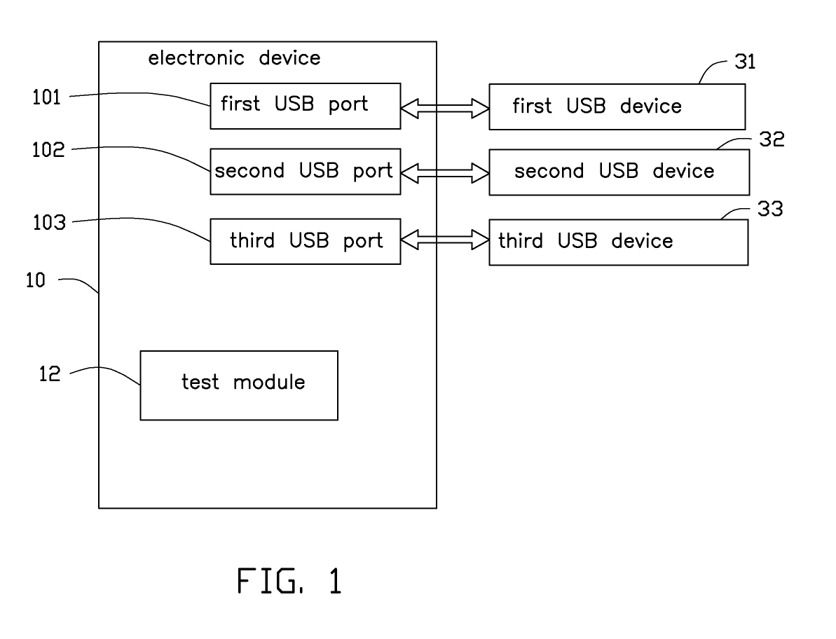

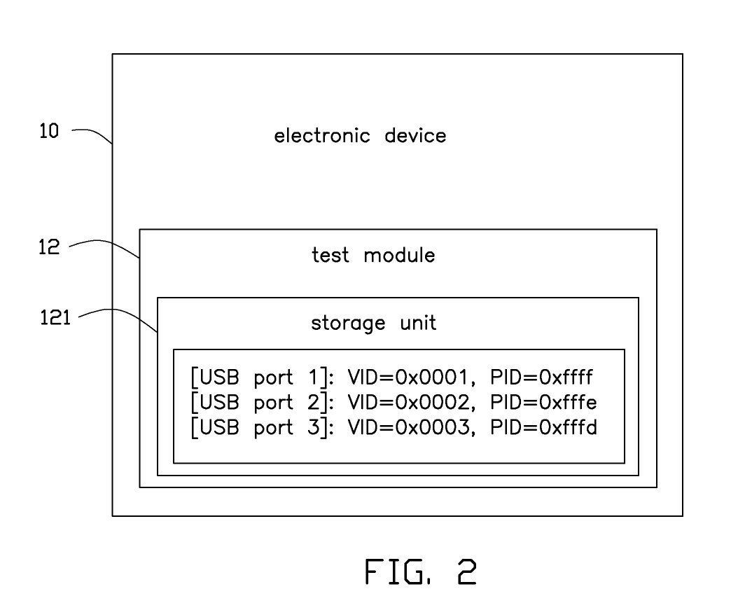

Referring to FIGS. 1 and 2, a system is used to test if an electronic device 10 is connected with correct peripheral USB device. In one embodiment, the electronic device 10 has three USB ports, which are, a first USB port 101, a second USB port 102, and a third USB port 103. A first USB device 31 is connected with the first USB port 101, a second USB device 32 is connected with the second USB port 102, and a third USB device 33 is connected with the third USB port 103. The three USB devices 31, 32, and 33 are different peripheral devices, such as keyboard, mouse, camera, etc. Each USB devices 31, 32, and 33 has a VID and a PID.

The electronic device 10 includes a test module 12, which can connect to the USB ports of the electronic device 10. The test module 12 includes a storage unit 121. For a peripheral device configuration of the electronic device 10, the storage unit 121 stores corresponding VIDs and PIDs of corresponding peripheral USB devices, which could be connected to the electronic device 10. For example, in a peripheral device configuration, the first USB port 101 is designed to connect to a keyboard whose VID is 0x0001, and whose PID is 0xffff. The second USB port 102 is designed to connect to a mouse, whose VID is 0x0002, and whose PID is 0xfffe. The third USB port 103 is designed to connect to a camera, whose VID is 0x0003, and whose PID is 0xfffd. Therefore, the storage unit 121 stores the following information: [USB port 1]: VID=0x0001, PID=0xffff; [USB port 2]: VID=0x0002, PID=0xfffe; [USB port 3]: VID=0x0003, PID=0xfffd. If the USB ports of the electronic device 10 are designed to connect with other peripheral USB devices, the information stored in the storage unit 121 can be modified. For unassigned USB ports of the electronic device 10, the VID and PID are stored as 0x0000.

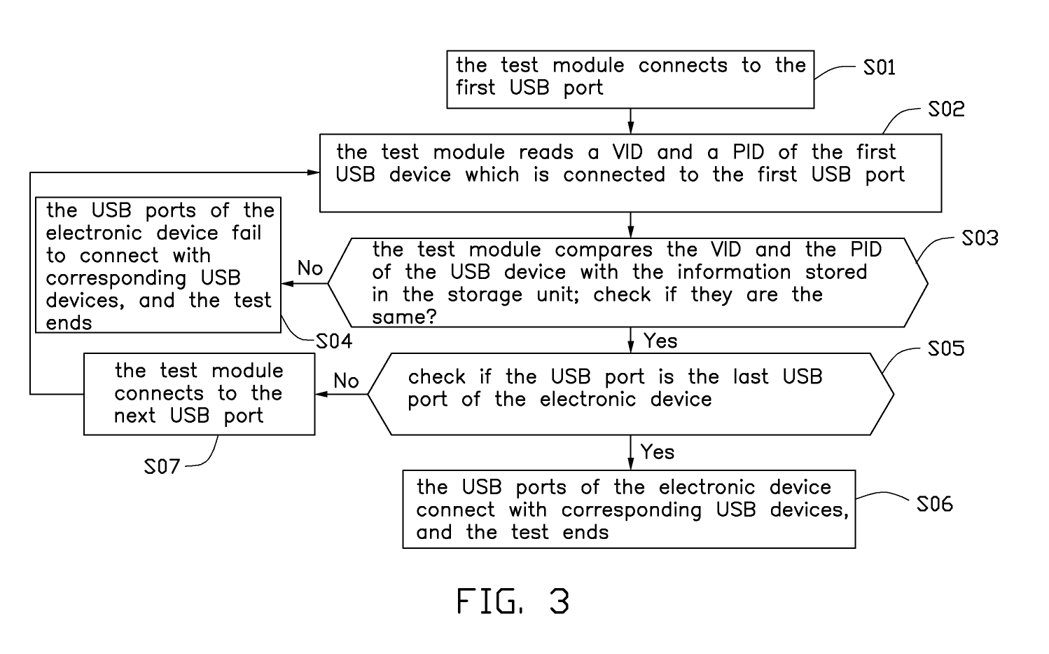

Referring to FIG. 3, a method for testing USB devices of the electronic device 10 includes the following steps:

In step S01, the test module 12 connects to the first USB port 101.

In step S02, the test module 12 reads a VID and a PID of the first USB device 31 which is connected to the first USB port 101.

In step S03, the test module 12 compares the VID and the PID of the USB device 31 with the information stored in the storage unit 121. For example, the information of “[USB port 1]: VID=0x0001, PID=0xffff” is compared to the VID and the PID of the first USB device 31. If they are the same, go to step S05. If they are not the same, go to step S04.

In step S04, the USB ports of the electronic device 10 fail to connect with corresponding USB devices, and the test ends.

In step S05, check if the USB port is the last USB port of the electronic device 10. If it is, go to step S06. If it is not, go to step S07.

In step S06, the USB ports of the electronic device 10 connect with corresponding USB devices, and the test ends.

In step S07, the test module 12 connects to the next USB port, repeats step S02 to read a VID and a PID of the next USB device which is connected to the next USB port.

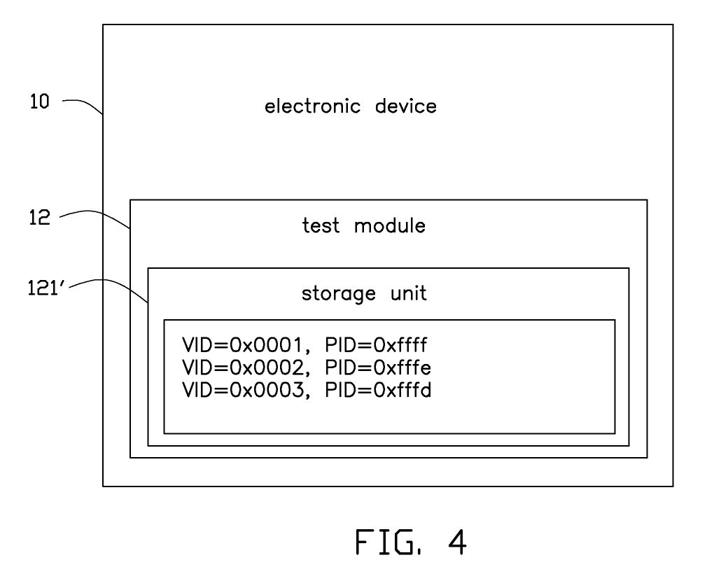

In another embodiment, there is not need to test a particular peripheral device connected to a particular USB port of the electronic device 10, such as the USB device 31 connected to the USB port 1 in the above embodiment. In the present embodiment, it tests if all of the required peripheral devices of the electronic device 10 are connected to the electronic device 10. Referring to FIG. 4, in the present embodiment, a storage unit 121′ of the electronic device 10 stores the following information: VID=0x0001, PID=0xffff; VID=0x0002, PID=0xfffe; VID=0x0003, PID=0xfffd. The above information is not related to the USB port of the electronic device 10.

Corresponding to the information stored in the storage unit 121′, another method for testing USB devices of the electronic device 10 includes the following steps:

In step 501, the test module 12 in turn connects to the USB ports of the electronic device 10, and reads a data package which includes a VID and a PID when the test module 12 connected to a USB port;

In step 502, the test module 12 gets rid of the data package whose VID and PID are 0x0000;

In step 503, the test module 12 compares the remaining data packages with the information stored in the storage unit 121′; if they are the same, go to step 504. If they are not the same, go to step 505.

In step 504, the USB ports of the electronic device 10 connect with correct USB devices, and the test ends.

In step 505, the USB ports of the electronic device 10 fail to connect with correct USB devices, and the test ends.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A system for testing peripheral USB devices of an electronic device, comprising:
a plurality of USB ports configured on the electronic device, the plurality of USB ports connecting to a plurality of USB devices, each of the USB device comprising a VID and a PID;
a test module comprising a storage module which stores a plurality of VIDs and PIDs;
wherein the test module communicating with the plurality of USB ports, reads VIDs and PIDs of the plurality of USB devices, and compares the VIDs and PIDs of the plurality of USB devices with the VIDs and PIDs stored in the storage module.

2. The system of claim 1, wherein the VIDs and PIDs stored in the storage module correspond to peripheral devices which are designed to connect to the electronic device.

3. The system of claim 2, wherein the VIDs and PIDs stored in the storage module can be modified according to a peripheral device configuration of the electronic device.

4. The system of claim 2, wherein the peripheral devices comprises at least one of a keyboard, a mouse, and a camera.

5. The system of claim 1, wherein the plurality of USB ports comprise a first port, a second port, and a third port, the first USB port is designed to connect to a keyboard, the second USB port is designed to connect to a mouse, and the third USB port is designed to connect to a camera.

6. A method for testing peripheral USB devices of an electronic device, comprising the following steps:
connecting a test module to a USB port of the electronic device;
reading a VID and a PID of a USB device which is connected to the USB port by the test module; and
comparing the VID and PID of the USB device with codes stored in a storage module of the test module.

7. The method of claim 6, wherein the codes represent a VID and a PID of a peripheral device which is designed to be connected to the USB port of the electronic device.

8. The method of claim 7, wherein the VIDs and PIDs stored in the storage module can be modified according to a peripheral device configuration of the electronic device.

9. The method of claim 7, wherein the peripheral device is one of a keyboard, a mouse, and a camera.
